(19) United States
(12) Patent Application Publication
(10) Pub. No.: US 2025/0310039 A1
(43) Pub. Date: Oct. 2, 2025

(54) MULTIPLE SATELLITE AND TERRESTRIAL BASE STATION COORDINATION FUNCTIONALITY

(71) Applicant: T-MOBILE INNOVATIONS LLC, Overland Park, KS (US)

(72) Inventor: Akin OZOZLU, McLean, VA (US)

(21) Appl. No.: 18/624,886

(22) Filed: Apr. 2, 2024

(51) Int. Cl. H04L 1/1867; H04W 64/00; H04W 84/06

(52) U.S. Cl. CPC H04L 1/1893; H04W 64/006; H04W 84/06

(57) ABSTRACT

At a high level, the technology disclosed herein relates to terrestrial and non-terrestrial coordination functionality. For example, one or more triggers (e.g., provided by one or more network components) can cause a user device (e.g., a cellular phone, smart phone, tablet, smart device, vehicle, etc.) to perform packet duplication, such that one packet from the packet duplication is to be transmitted from the user device to a non-terrestrial station (e.g., a low earth orbit satellite) and such that another packet from the packet duplication is to be transmitted from the user device to a terrestrial station (e.g., a base station). This multi-state operation for the user device can allow for communications with both the non-terrestrial station and the terrestrial station (e.g., via a multi-path server and a multi-path stack of the user device) so that uplink and downlink data associated with each station can be recovered to improve communication reliability.

### SUMMARY

A high-level overview of various aspects of the invention are provided here to offer an overview of the disclosure and to introduce a selection of concepts that are further described below in the detailed description section. This summary is not intended to identify key features or essential features of the claimed subject matter, nor is it intended to be used as an aid in isolation to determine the scope of the claimed subject matter.

According to various aspects of the technology disclosed herein, systems, methods, media, etc., are provided for terrestrial and non-terrestrial coordination functionality. For example, a trigger may be transmitted (e.g., via a multi-path server) to a user equipment (UE) to cause the UE to perform packet duplication, such that one packet from the packet duplication is to be transmitted from the UE to a non-terrestrial station and another packet from the packet duplication is to be transmitted from the UE to a terrestrial station. In some aspects, the trigger may also cause the UE to stop the packet duplication (e.g., based on radio frequency fluctuations corresponding to uplink data associated with the non-terrestrial station, based on other radio frequency measurements corresponding to the non-terrestrial station, etc.).

Further, based on the trigger, various uplink and downlink data associated with the terrestrial station and the non-terrestrial station may be recovered for improving communication reliability. For example, the UE may establish one or more radio frequency links with both the terrestrial station and the non-terrestrial station based on the trigger. Based on these radio frequency links and the packet duplication, the UE may utilize one or more particular uplinks or one or more particular downlinks, or a combination thereof (e.g., two particular uplinks simultaneously, a particular uplink and a particular downlink, etc.), for one or more communication services. As another example, a dynamic selection between a non-terrestrial station uplink and a terrestrial station uplink can be implemented (e.g., via the multi-path server) for a UE communication based on a combination of non-terrestrial station uplink data and terrestrial station uplink data recovered in response to the UE performing the packet duplication. Additionally or alternatively, in some aspects, a dynamic selection between a non-terrestrial station downlink and a terrestrial station downlink can be implemented in response to the UE performing the packet duplication.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 depicts an example operating environment for terrestrial and non-terrestrial coordination functionality, in accordance with embodiments herein;

FIG. 2 depicts an example block diagram for terrestrial and non-terrestrial coordination functionality, in accordance with embodiments herein;

FIG. 3 illustrates an example network-perspective flowchart for terrestrial and non-terrestrial coordination functionality, in accordance with aspects herein;

FIG. 4 depicts an example non-terrestrial station and example non-terrestrial station functionality corresponding to the present technology, in accordance with aspects herein; and

FIG. 5 depicts an example user device and example user device functionality for implementation of the present technology, in accordance with aspects herein.

### DETAILED DESCRIPTION

The subject matter of the present invention is being described with specificity herein to meet statutory requirements. However, the description itself is not intended to limit the scope of this patent. Rather, the inventors have contemplated that the claimed subject matter might also be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described. As such, although the terms “step” and/or “block” may be used herein to connote different elements of systems and/or methods, the terms should not be interpreted as implying any particular order and/or dependencies among or between various components and/or steps herein disclosed unless and except when the order of individual steps is explicitly described. The present disclosure will now be described more fully herein with reference to the accompanying drawings, which may not be drawn to scale and which are not to be construed as limiting. Indeed, the present invention can be embodied in many different forms and should not be construed as limited to the aspects set forth herein.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022).

As used herein, the term a “communication service” (e.g., provided by a terrestrial station, satellite station, or another type of access point) may be synonymous with network access technology, a communication protocol and umbrella term used to refer to the particular technological standard/protocol that governs a communication associated with user equipment (UE). Examples may include 3G, 4G, 5G, 6G, another generation technology, 802.11x, etc., or one or more combinations thereof.

The term “network component” may correspond to an access point that transmits signals to a UE and receives signals from the UE in order to allow the UE to connect to a broader data or cellular network (including by way of one or more intermediary networks, gateways, or the like).

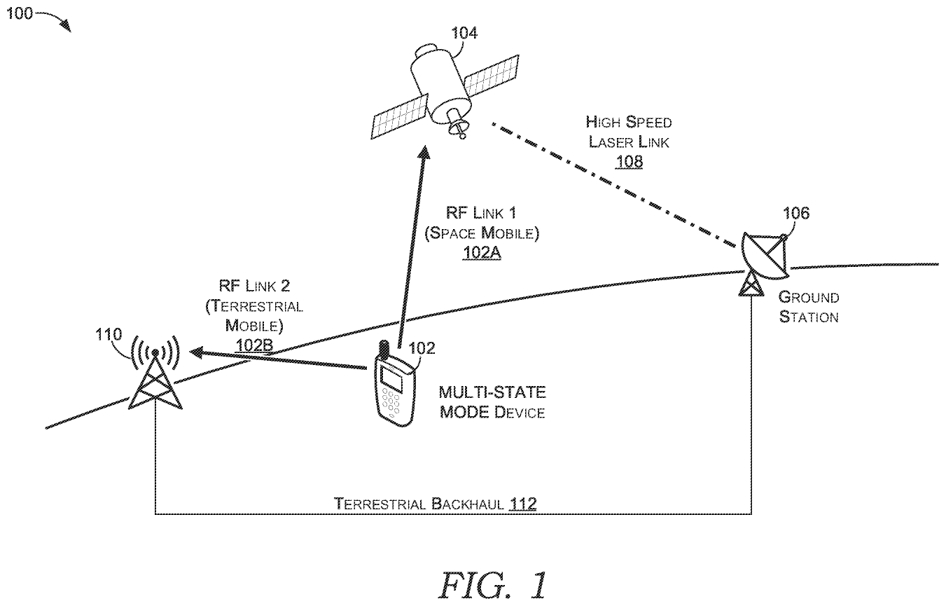

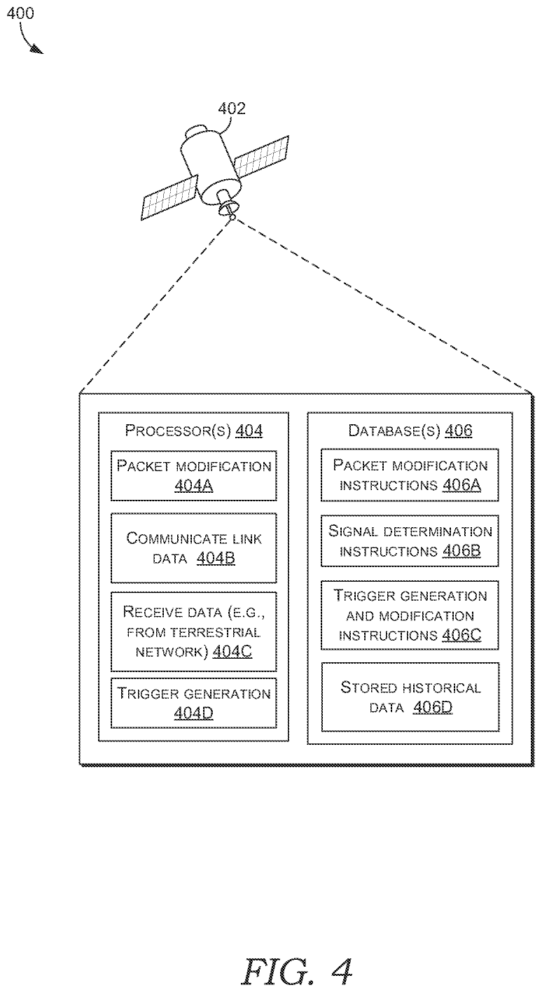

The term “non-terrestrial” station may refer to a non-terrestrial base station that is distinguished from a terrestrial base station on the basis of its lack of ground coupling. Some examples of a non-terrestrial station can include a low earth orbit satellite, a medium earth orbit satellite, a bent-pipe satellite, a regenerative satellite, a space satellite, a balloon, a dirigible, an airplane, a drone, an unmanned aerial vehicle, a geosynchronous or geostationary earth orbit satellite, another type of satellite, another type of non-terrestrial station, or one or more combinations thereof. A non-terrestrial station may be, in an embodiment, similar to non-terrestrial station 104 described herein with respect to FIG. 1 or similar to non-terrestrial station 402 described herein with respect to FIG. 4.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

By way of background, a UE receiving and utilizing direct broadband connectivity through a non-terrestrial station may experience one or more challenges corresponding to the relevant uplink. For example, link losses associated with this uplink may occur due to the vast distance between the non-terrestrial station and the UE (e.g., up to 1,500 km away from the UE at zenith, and even further when not directly overhead). An example illustration may include a UE experiencing free space loss of 112 dB while operating at 2 GHz and being located approximately 5 km away from a terrestrial base station, whereas the UE may be experiencing a path loss of 50 dB greater when utilizing direct broadband connectivity through a non-terrestrial station located about 1,500 km away from the UE. In addition, the link losses associated with this uplink may occur due to non-terrestrial antenna gain, noise temperature, equivalent isotropic radiated power from the UE, another non-terrestrial uplink factor, or one or more combinations thereof.

In addition, a UE receiving and utilizing broadband connectivity through a terrestrial station may also experience one or more challenges corresponding to the terrestrial station uplink. For instance, the terrestrial station uplink may experience interference (e.g., from other UEs or other types of user devices or geographical obstructions that can cause packet loss, reduced data rates, dropped connections, etc. By way of example, buildings or trees may cause a decrease in the terrestrial station uplink signal strength. As another example, high terrestrial station network traffic may affect the congestion of the terrestrial station uplink signal strength for UEs. Further, a UE receiving and utilizing connectivity through a terrestrial station may encounter issues with a terrestrial downlink (e.g., signal attenuation, network congestion, signal interferences, weaker signals at a cell edge, etc.), or a UE receiving and utilizing direct connectivity through a non-terrestrial station may encounter issues with a non-terrestrial downlink (e.g., interference levels corresponding to the main lobe of the non-terrestrial station overlapping with a main lobe of a receiving antenna's pattern gain of an incumbent service).

Embodiments of the technology discussed herein provide various improvements to the challenges discussed above. For example, the presently disclosed technology can cause a user device/UE to implement multi-state operations of one or more user devices, allowing for UE communications with both the non-terrestrial station and the terrestrial station (e.g., via a multi-path server and a multi-path stack of the user device) so that uplink data, downlink data, or one or more combinations thereof, associated with each of the non-terrestrial station and the terrestrial station can be recovered to improve communication reliability. In addition, the presently disclosed technology can also cause the user device to stop one or more of the multi-state operations based on one or more radio frequency conditions corresponding to the non-terrestrial station, the terrestrial station, or one or more combinations thereof, to improve the capacity associated with communication services provided by the non-terrestrial station and the terrestrial station.

In an embodiment, a system for terrestrial and non-terrestrial coordination functionality is provided. The system may comprise one or more processors and computer memory storing computer-usable instructions that, when executed by the one or more processors, cause the one or more processors to perform operations. The operations may comprise transmitting a trigger to a user device that causes the user device to perform packet duplication, such that one packet from the packet duplication is to be transmitted from the user device to a non-terrestrial station and such that another packet from the packet duplication is to be transmitted from the user device to a terrestrial station. The operations may also comprise receiving, based on the trigger, non-terrestrial station uplink data from the non-terrestrial station that corresponds to the one packet transmitted from the user device. The operations may also comprise receiving, based on the trigger, terrestrial station uplink data from the terrestrial station that corresponds to the other packet transmitted from the user device. In an aspect of this embodiment, the operations can also comprise adding a combination of the terrestrial station uplink data and the non-terrestrial station uplink data to each packet from the packet duplication and transmitting this to the user device.

In another embodiment, a system for terrestrial and non-terrestrial coordination functionality is provided. The system may comprise one or more processors and computer memory storing computer-usable instructions that, when executed by the one or more processors, cause the one or more processors to perform operations. The operations may comprise transmitting a trigger to a user device that causes the user device to perform packet duplication, such that one packet from the packet duplication is to be transmitted from the user device to a non-terrestrial station and such that another packet from the packet duplication is to be transmitted from the user device to a terrestrial station. The operations may also comprise receiving, based on the trigger, non-terrestrial station downlink data from the non-terrestrial station that corresponds to the one packet transmitted from the user device. The operations may also comprise receiving, based on the trigger, terrestrial station downlink data from the terrestrial station that corresponds to the other packet transmitted from the user device. In an aspect of this embodiment, the operations can also comprise adding a combination of the terrestrial station downlink data and the non-terrestrial station downlink data to each packet from the packet duplication and transmitting this to the user device.

In another example embodiment, a method for terrestrial and non-terrestrial coordination functionality is provided. The method may comprise transmitting, via one or more network components, a trigger to a user device that causes the user device to perform packet duplication, such that one packet from the packet duplication is to be transmitted from the user device to a non-terrestrial station and such that another packet from the packet duplication is to be transmitted from the user device to a terrestrial station. The method may also comprise causing, via the one or more network components and based on the user device performing the packet duplication, the user device to utilize a terrestrial station uplink over a non-terrestrial station uplink. In some embodiments, the user device can be caused to utilize the terrestrial station uplink over the non-terrestrial station uplink based on determining, via the one or more network components, that the user device has transmitted a number of Hybrid Automatic Repeat Requests (HARQs), to the non-terrestrial station within a period of time, that is over a threshold.

In another example embodiment, one or more non-transitory computer storage media are provided. The one or more non-transitory computer storage media may have computer-executable instructions embodied thereon, that when executed by at least one processor, cause the at least one processor to perform a method. The method may comprise transmitting a trigger to a user device that causes the user device to perform packet duplication, such that one packet from the packet duplication is to be transmitted from the user device to a non-terrestrial station and that another packet from the packet duplication is to be transmitted from the user device to a terrestrial station. The method may also comprise receiving, based on the user device performing the packet duplication, non-terrestrial station uplink data and terrestrial station uplink data and combining the non-terrestrial station uplink data with the terrestrial station uplink data. The method may also comprise dynamically selecting between a non-terrestrial station uplink and a terrestrial station uplink for a user device communication based on the combination of the non-terrestrial station uplink data and the terrestrial station uplink data.

In another example embodiment, one or more non-transitory computer storage media are provided. The one or more non-transitory computer storage media may have computer-executable instructions embodied thereon, that when executed by at least one processor, cause the at least one processor to perform a method. The method may comprise transmitting a trigger to a user device that causes the user device to perform packet duplication, such that one packet from the packet duplication is to be transmitted from the user device to a non-terrestrial station and that another packet from the packet duplication is to be transmitted from the user device to a terrestrial station. The method may also comprise receiving, based on the user device performing the packet duplication, radio frequency conditions corresponding to the non-terrestrial station and the terrestrial station and combining the radio frequency conditions of the non-terrestrial station with the radio frequency conditions of the terrestrial station. The method may also comprise dynamically selecting between a non-terrestrial station downlink and a terrestrial station downlink for a user device communication based on the combination of the radio frequency conditions.

### Example Operating Environments

Turning now to FIG. 1, example operating environment 100 is illustrated in accordance with one or more embodiments disclosed herein. At a high level, the example operating environment 100 comprises user device 102, radio frequency (RF) link 102A, RF link 102B, non-terrestrial station 104, ground station 106, high-speed laser link 108, terrestrial station 110, and terrestrial backhaul 112.

Example operating environment 100 is but one example of a suitable environment for the technology and techniques disclosed herein, and is not intended to suggest any limitation as to the scope of use or functionality of the invention. Neither should the environment 100 be interpreted as having any dependency or requirement relating to any one or combination of components illustrated. For example, other embodiments of example operating environment 100 may have additional user devices operating in multi-state mode, additional terrestrial stations, or additional non-terrestrial stations.

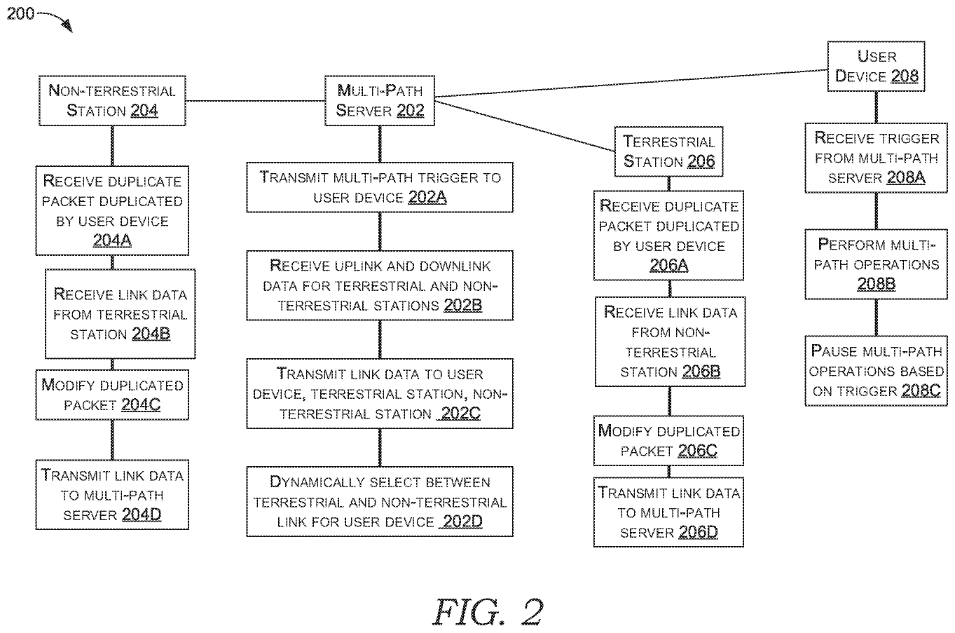

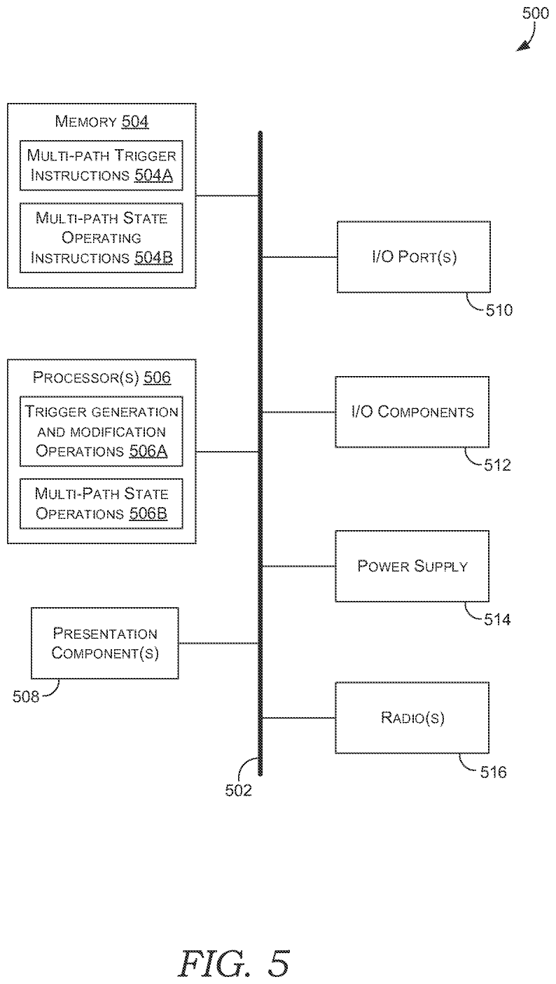

User device 102 may be a device that has the capability of transmitting or receiving one or more signals to or from a terrestrial station and a non-terrestrial station. In some embodiments, a “user device” be referred to as a “computing device,” “mobile device,” “user equipment (UE),” or “wireless communication device.” A user device, in some implementations, may take on a variety of forms, such as a PC, a laptop computer, a tablet, a mobile phone, a PDA, a server, an internet-of-things device, a wireless local loop station, an Internet of Everything device, a machine type communication device, an evolved or enhanced machine type communication device, or any other device that is capable of communicating with the terrestrial station and non-terrestrial station. A user device may be, in an embodiment, user device 208 described herein with respect to FIG. 2 or user device 500 described herein with respect to FIG. 5.

The non-terrestrial station 104 may be configured as a non-terrestrial network (e.g., a 3GPP non-terrestrial network) or part of a non-terrestrial network. For example, the non-terrestrial network may be connecting one or more gateways (e.g., ground station 106 comprising one or more devices or a system of components configured to provide an interface between a terrestrial network and the non-terrestrial network) to other networks. In some embodiments, a coverage beam from the non-terrestrial station 104 may not sweep across the ground as the non-terrestrial station 104 traverses overhead, and instead remains fixed over a given terrestrial geographical area. In some embodiments, the non-terrestrial station 104 can establish a radio frequency link with the user device 102 using a Uu interface. In embodiments, the non-terrestrial station 104 can broadcast, via a non-terrestrial downlink, one or more communication services to the user device 102 (e.g., 5G services, 6G services, mission critical access, other types of communication services, protocols, or functionality, or one or more combinations thereof).

In embodiments, the high-speed laser link 108 can involve optical signals in the form of laser beams for data transmission. For example, the high-speed laser link 108 can include one or more optical communication links or optical inter-satellite links to establish communication between the non-terrestrial station 104 and the ground station 106. For example, the non-terrestrial station 104 may have one or more laser transmitters for generating one or more laser beams for carrying transmitted data via one or more focused beams. In some embodiments, the non-terrestrial station 104 and the ground station 106 each have an optical system for directing and receiving the high-speed laser link 108. Additionally, based on the high-speed laser link 108, the user device 102 can establish an RF link 102A with the non-terrestrial station 104 (e.g., via a Hybrid Automatic Repeat Request (HARQ)).

Terrestrial station 110, in some embodiments, may be a macro base station, a small cell, femtocell, relay base station, another type of network access technology access point, or one or more combinations thereof. The terrestrial station 110 can include one or more single physical transmission and reception points (e.g., an antenna of the base station corresponding to a cell of the base station), multiple physical transmission and reception points (e.g., in which one or more of the multiple physical transmission and reception points are co-located, in which one or more of the multiple physical transmission and reception points are not co-located, a distributed antenna system, etc.), or one or more combinations thereof. The user device 102 can establish an RF link 102B with the terrestrial station 110, and the terrestrial station can provide one or more communication services (e.g., Internet browsing, Wi-Fi, Voice over IP, gaming, High Frequency Trading, SMS, MMS, an emergency medical service, another type of communication service, or one or more combinations thereof) to the user device 102 (e.g., via a terrestrial station downlink and RF link 102B).

Terrestrial backhaul 112 (e.g., a terrestrial fiber backhaul) can connect terrestrial station 110 and ground station 106. Additionally or alternatively, one or more non-terrestrial backhauls may be used for communications between the terrestrial network and the non-terrestrial network. In some embodiments, a plurality of aggregation points can be used for one or more backhauls between the terrestrial network and the non-terrestrial network to collect and consolidate traffic from a plurality of terrestrial stations and a plurality of ground stations before forwarding to the network (e.g., core network).

In embodiments, one or more network components (e.g., a terrestrial network server, terrestrial station 110, non-terrestrial station 104, etc.) may transmit a trigger to the user device 102 that causes the user device 102 to perform packet duplication, such that one packet from the packet duplication is to be transmitted from the user device 102 via the RF link 102A to the non-terrestrial station 104, and such that another packet from the packet duplication is to be transmitted from the user device 102 via RF link 102B to a terrestrial station 110. The transmissions over the RF link 102A and RF link 102B can occur simultaneously. By way of example, this multi-state packet duplication via the user device 102 over the RF link 102A and RF link 102B can be triggered based on one or more radio frequency conditions associated with the non-terrestrial station 104, the terrestrial station 110, or one or more combinations thereof.

In some embodiments, the trigger transmitted to the user device 102 can cause the user device 102 to establish two paths: a non-terrestrial uplink (e.g., RF link 102A) from the user device 102 to the non-terrestrial station 104 and a terrestrial uplink (e.g., RF link 102B) from the user device 102 to the terrestrial station 110. Additionally or alternatively, based at least in part on the trigger, the non-terrestrial station 104 can establish a non-terrestrial downlink to the user device 102 while the terrestrial station 110 simultaneously establishes a terrestrial downlink to the user device 102. By way of example, an RF link with both the non-terrestrial station 104 and the terrestrial station 110 can be established based on a request (e.g., a Hybrid Automatic Repeat Request (HARQ) to the non-terrestrial station 104, a radio resource control (RRC) connection request for the terrestrial station 110, etc.) from the user device 102 and based on the trigger. In addition, in embodiments, the RF links with both the non-terrestrial station 104 and the terrestrial station 110 can be established based on the terrestrial backhaul 112 and the high-speed laser link 108.

In some embodiments, the RF links with each of the non-terrestrial station 104 and the terrestrial station 110 can correspond to the same frequency band (e.g., 1900 MHz or another frequency band). For example, when the trigger causes the user device 102 to operate in multi-path state via the packet duplication, the user device 102 can simultaneously transmit one packet from the packet duplication via the RF link 102A to the non-terrestrial station 104 over the same frequency band as the other packet from the packet duplication via RF link 102B to the terrestrial station 110.

In embodiments, the trigger (e.g., ˜1 bit) can cause the user device 102 to perform packet duplication based on radio frequency conditions of the RF link 102A, the RF link 102B, another link, or one or more combinations thereof. For instance, the user device 102 can initiate the packet duplication in response to transmitting a particular number of HARQs to the non-terrestrial station without receiving an acknowledgement. As another example, the user device 102 can initiate the packet duplication in response to the terrestrial station 110 determining that RF link 102A or RF link 102B has a particular energy level (e.g., 8 dB). For instance, the user device 102 can initiate the packet duplication based on a signal to noise ratio of the RF link 102B, a signal to interference plus noise ratio of the RF link 102B, another RF link 102B factor, or one or more combinations thereof. In another example, the user device 102 can initiate the packet duplication based on a terrestrial station downlink or a non-terrestrial station downlink having an overall signal strength that has decreased below a threshold (e.g., a 10 dB drop).

In some embodiments, based on the packet duplication, a combination of terrestrial station uplink data (e.g., corresponding to RF link 102B) and non-terrestrial station uplink data (e.g., corresponding to RF link 102A) can be used for selection diversity between utilizing the RF link 102A and the RF link 102B. By way of example, the terrestrial station uplink data and the non-terrestrial station uplink data, determined based on the packet duplication, can be transmitted to the user device 102. For instance, based on the packet duplication, the terrestrial network can have visibility from both the terrestrial station side and the non-terrestrial station side for determining which packet from the packet duplication to move to core network. In yet another example, based on a signal to noise ratio of the RF link 102A (or a signal to interference plus noise ratio of the RF link 102A, another characteristic of the RF link 102A, etc.) determined based on the packet duplication, and based on a characteristic of the RF link 102B determined from the packet duplication, the terrestrial network can have visibility from both the terrestrial station side and the non-terrestrial station side for determining which packet from the packet duplication to move to core network.

As illustrated in example block diagram 200 of FIG. 2, multi-path server 202 can perform various functions based on the packet duplication performed by the user device 208. For example, the multi-path server 202 can be configured to communicate with non-terrestrial station 204, terrestrial station 206, and user device 208. Some embodiments of the non-terrestrial station 204 can include non-terrestrial station 104 of FIG. 1, some embodiments of the terrestrial station 206 can include terrestrial station 110 of FIG. 1, and some embodiments of the user device 208 can include user device 102 of FIG. 1.

The multi-path server 202 can transmit a multi-path trigger to the user device 202A. Based on the user device 208 receiving the trigger from the multi-path server 208A, the user device 208 can perform multi-path operations 208B. By way of example, the multi-path operations can include performing packet duplication and transmitting one packet from the packet duplication from the user device 208 to the non-terrestrial station 204 and transmitting (e.g., simultaneously) another packet from the packet duplication to the terrestrial station 206. Stated differently, the non-terrestrial station 204 can receive the duplicate packet that the user device duplicated 204A and the terrestrial station 206 can receive the duplicate packet that the user device duplicated 206A.

Based on the user device transmitting the packets from the packet duplication, the non-terrestrial station 204 can modify the duplicated packet 204C (e.g., in some embodiments, modify based on receiving link data from the terrestrial station 204B, such as terrestrial station uplink or downlink data) and transmit non-terrestrial station uplink data to the multi-path server 204D. In some embodiments, the non-terrestrial station 204 transmits the modified duplicated packet to the multi-path server 202. By way of example, the modification can include adding non-terrestrial station uplink data to the duplicated packet.

Additionally, based on the user device 208 transmitting the packets from the packet duplication, the terrestrial station 206 can modify the duplicated packet 206C (e.g., in some embodiments, modify based on receiving link data from the non-terrestrial station 206B, such as non-terrestrial station uplink or downlink data) and transmit terrestrial station uplink data to the multi-path server 206D. In some embodiments, the terrestrial station 206 transmits the modified duplicated packet to the multi-path server 202. By way of example, the modification can include adding terrestrial station uplink data to the duplicated packet.

Based on these operations of the non-terrestrial station 204 and the terrestrial station 206, the multi-path server 202 can receive one or more of terrestrial station uplink or downlink data, non-terrestrial station uplink or downlink data 202B, or one or more combinations thereof, and transmit each of these to the user device 208 (e.g., transmit to the user device, terrestrial station, or non-terrestrial station 202C). Based on the one or more of terrestrial station uplink or downlink data, non-terrestrial station uplink or downlink data, or one or more combinations thereof, the multi-path server 202 can dynamically select between a non-terrestrial station uplink and a terrestrial station uplink or dynamically select between a non-terrestrial station downlink and a terrestrial station downlink 202D (e.g., for communications to or from the user device).

In some embodiments, the dynamic selection between the non-terrestrial station uplink and the terrestrial station uplink is determined by the multi-path server 202 based on receiving, from the user device, a signal strength of a non-terrestrial station downlink of the non-terrestrial station 204. In some embodiments, the dynamic selection between the non-terrestrial station uplink and the terrestrial station uplink is determined by the multi-path server 202 based on receiving, from the user device, a number of HARQs that the user device transmitted to the non-terrestrial station within a period of time. In some embodiments, the multi-path server 202 can cause the user device to utilize the terrestrial station uplink over the non-terrestrial uplink based on a signal strength of the non-terrestrial station downlink being below a threshold.

In some embodiments, the multi-path server 202 can cause the user device 208 to utilize a non-terrestrial station downlink over a terrestrial station downlink based on combining the non-terrestrial station downlink data and the terrestrial station downlink data received from the non-terrestrial station 204 and the terrestrial station 206. In some embodiments, the trigger also causes the user device to stop the packet duplication (e.g., based on a radio frequency fluctuation corresponding to a non-terrestrial uplink), such that the user device 208 can pause the multi-path operations based on the trigger 208C.

### Example Flowchart

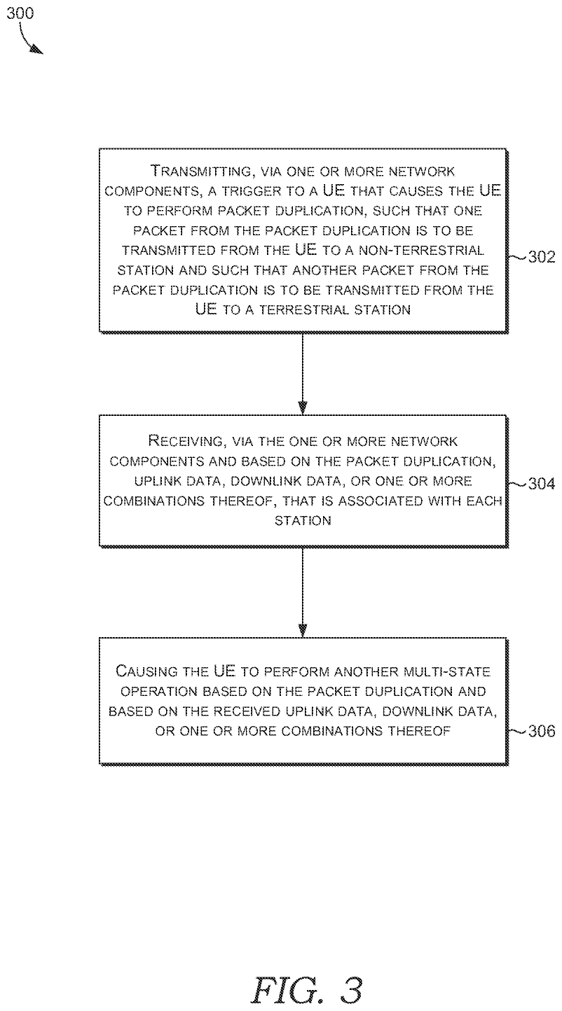

Having described the example embodiments discussed above, an example flowchart is described below with respect to FIG. 3. Example flowchart 300 begins at step 302 with transmitting, via one or more network components (e.g., multi-path server 202 of FIG. 2), a trigger to a user device (e.g., user device 500 of FIG. 5) that causes the user device to perform packet duplication, such that one packet from the packet duplication is to be transmitted from the user device to a non-terrestrial station (e.g., non-terrestrial station 104 of FIG. 1, non-terrestrial station 204 of FIG. 2, non-terrestrial station 402 of FIG. 4) and such that another packet from the packet duplication is to be transmitted from the user device to a terrestrial station (e.g., terrestrial station 110 of FIG. 1).

In some embodiments, the user device is located within a cell edge associated with the terrestrial station (e.g., the cell edge being a boundary or outer limit of a network cell coverage range associated with the terrestrial station), wherein the trigger causes the user device to perform the packet duplication based on the user device being located within the cell edge. As another example, the trigger may be transmitted based on determining, via the one or more network components, that the user device is located within the cell edge associated with the terrestrial station. For instance, the one or more network components may determine that the user device is located within the cell edge based on a transmit power of the user device associated with a request (e.g., an RRC request), an uplink budget corresponding to the user device at the cell edge, a user device communication with a cell edge device, a signal quality of a signal received by the user device from the terrestrial station, a latency of a signal received by the user device from the terrestrial station, a Reference Signal Received Power (RSRP) (a received power level of the reference signals from the terrestrial station), a Reference Signal Received Quality (RSRQ), a measurement report provided to the network, a unique Cell ID of the terrestrial station, an enhanced cell ID, a time-of-arrival measurement, an observed time difference of arrival, a Global Navigation Satellite System signal, a Wi-Fi positioning technique, a short-range wireless technique, an accelerometer measurement, a gyroscope measurement, a magnetometer measurement, another type of cell edge factor or measurement, or one or more combinations thereof. In this way, the trigger may be transmitted or the packet duplication operations may be triggered based on one or more of these cell edge factors.

At step 304, based on the packet duplication, the one or more network components can receive non-terrestrial station uplink data (e.g., from non-terrestrial station 104 and based on the high-speed laser link 108 and terrestrial backhaul 112 of FIG. 1), terrestrial uplink data (e.g., from terrestrial station 110 of FIG. 1), or multiple combinations thereof. Additionally or alternatively, based on the packet duplication, the one or more network components can receive non-terrestrial station downlink data (e.g., based on a communication from the non-terrestrial station 104 to user device 102 of FIG. 1 in response to the packet duplication), terrestrial downlink data (e.g., based on a communication from the terrestrial station 110 to user device 102 of FIG. 1 in response to the packet duplication), or multiple combinations thereof.

In some embodiments, the non-terrestrial uplink data may include a number of Hybrid Automatic Repeat Requests (HARQs) transmitted by the user device to the non-terrestrial station, payload data corresponding to the packet transmitted to the non-terrestrial station during the packet duplication, user device positioning data, signal-to-noise ratio, signal-to-interference-plus-noise ratio, other quality of service parameters, attenuation corresponding to the receiver of the non-terrestrial station, interference at the receiver of the non-terrestrial station, power signal at the receiver of the non-terrestrial station, non-terrestrial station receiver gains, bandwidth, noise measurements, packet collision data, propagation time, frame airtime values, spreading factors, fading measurements, received signal strength indications, other types of non-terrestrial uplink data, or one or more combinations thereof.

In some embodiments, the non-terrestrial downlink data may include acknowledgement data associated with the packet transmitted to the non-terrestrial station during the packet duplication, acknowledgement data associated with an HARQ request, non-terrestrial station transmitter gains, attenuation or interference at the user device transceiver, bandwidth, noise measurements, signal-to-noise ratio, signal-to-interference-plus-noise ratio, other quality of service parameters, control signal data, synchronization signal data, other types of non-terrestrial downlink data, or one or more combinations thereof. In some embodiments, non-terrestrial uplink data may be inferred from a number of HARQs transmitted by one or more user devices (e.g., at one or more locations of a cell edge, at a plurality of locations including an urban or suburban area, etc.) to the non-terrestrial station, within a period of time, that is over a threshold.

At step 306, the one or more network components can cause the user device to perform another multi-state operation based on the packet duplication and based on the received non-terrestrial station uplink data, terrestrial station uplink data, non-terrestrial station downlink data, terrestrial station downlink data, or one or more combinations thereof. For example, the one or more network components can cause the user device to perform another multi-state operation based on combining the non-terrestrial station uplink data with the terrestrial station uplink data for transmission to the user device. As another example, the one or more network components can cause the user device to perform another multi-state operation based on combining the non-terrestrial station downlink data with the terrestrial station downlink data for transmission to the user device. In embodiments, other combinations can be provided to the user device.

In some embodiments, the one or more network components can cause the user device to utilize a terrestrial station uplink over a non-terrestrial station uplink based on the combined non-terrestrial station uplink data and terrestrial station uplink data. For example, the one or more network nodes can utilize a Packet Data Convergence Protocol, the fifth layer of the Open Systems Interconnection (OSI) model (or another model) or another layer within OSI (or other model) to combine the non-terrestrial station uplink data and the terrestrial station uplink data for transmission to the user device. In an aspect of this implementation, the one or more network components can cause the user device to utilize the terrestrial station uplink based on a signal strength of the non-terrestrial station downlink being below the threshold (e.g., by inferring non-terrestrial station uplink data using non-terrestrial uplink data). Additionally or alternatively, the one or more network components can cause the user device to utilize a non-terrestrial station downlink over a terrestrial station downlink based on the combined non-terrestrial station downlink data and terrestrial station downlink data.

In some embodiments, the one or more network components can cause the user device to perform a multi-state operation by dynamically selecting between a non-terrestrial station uplink and a terrestrial station uplink for a user device communication based on the combination of the non-terrestrial station uplink data and the terrestrial station uplink data. For instance, the one or more network components can cause the user device to utilize the terrestrial station uplink at an initial instance, and later cause the user device to utilize the non-terrestrial station uplink instead (e.g., based on a changed radio frequency link characteristic). Alternatively, the one or more network components can cause the user device to utilize the non-terrestrial station uplink at an initial instance, and later cause the user device to utilize the terrestrial station uplink instead (e.g., based on a changed radio frequency link characteristic). In some embodiments, the dynamic selection between the non-terrestrial station uplink and the terrestrial station uplink may be further based on the one or more network components receiving, from the user device, a number of Hybrid Automatic Repeat Requests (HARQs) that the user device transmitted to the non-terrestrial station within a period of time, a signal strength of the non-terrestrial station downlink of the non-terrestrial station, or one or more combinations thereof.

Additionally or alternatively, the one or more network components can cause the user device to perform a multi-state operation by dynamically selecting between a non-terrestrial station downlink and a terrestrial station downlink for a user device communication based on the combination of the non-terrestrial station downlink data and the terrestrial station downlink data. By way of example, the one or more network components can cause the user device to utilize the terrestrial station downlink at an initial instance, and later cause the user device to utilize the non-terrestrial station downlink instead (e.g., based on a changed radio frequency link characteristic).

In embodiments, the trigger also causes the user device to stop the packet duplication (e.g., upon the one or more network components further determining that a plurality of radio frequency measurements, measured within a period of time and corresponding to the non-terrestrial station uplink, are within a threshold range; upon determining that a radio frequency fluctuation, corresponding to a plurality of non-terrestrial uplink data received upon the user device performing a plurality of packet duplications, is within a threshold range; etc.). In some embodiments, the one or more network components can determine that the user device has stopped the packet duplication (e.g., based on determining that the radio frequency fluctuation is within the threshold range). Continuing this example embodiment, the one or more network nodes may also determine, at a time after determining that the radio frequency fluctuation is within the threshold range, that the radio frequency fluctuation (or plurality of radio frequency measurements) is no longer within the threshold range. Further, the one or more network nodes may receive additional non-terrestrial station uplink data and additional terrestrial station uplink data based on the radio frequency fluctuation no longer being within the threshold range and based on the trigger. Furthermore, the one or more network nodes may combine the additional terrestrial station uplink data and the additional non-terrestrial station uplink data for transmission to the user device for the performance a multi-state operation.

### Example Non-Terrestrial Station

Referring now to FIG. 4, example diagram 400 is depicted of an example non-terrestrial station functionality suitable for use in implementations of the present disclosure. Example diagram 400 of non-terrestrial station 402 is but one example of suitable non-terrestrial station functionality and is not intended to suggest any limitation as to the scope of use or functionality of the invention. Neither should example non-terrestrial station 402 be interpreted as having any dependency or requirement relating to any one or combination of components illustrated. In some embodiments, the non-terrestrial station 402 is the same as or similar to non-terrestrial station 104 of FIG. 1.

Example diagram 400 includes non-terrestrial station 402 having one or more processors 404 and one or more databases 406. Some functionality of the one or more processors 404 may include packet modification 404A, communication of link data 404B, receiving data 404C (e.g., from a terrestrial network based on high-speed laser link 108 and the terrestrial backhaul 112 of FIG. 1, from a user device 102 based on RF link 102A of FIG. 1, etc.), and trigger generation 404D. The one or more databases 406 may include packet modification instructions 406A, signal determination instructions 406B, trigger generation and modification instructions 406C, and stored historical data 406D.

In some embodiments, the one or more processors 404 may include a radiation-hardened processor, a field-programmable gate array, a system-on-chip processor, a radiation-tolerant microcontroller, a digital signal processor, an application-specific integrated circuit, a quad-core and multi-core processor, a PowerPC processor, another type of non-terrestrial processor, or one or more combinations thereof. In some embodiments, the one or more processors 404 may also have memory. In addition, in some embodiments, the one or more databases 406 may include radiation-hardened memory, flash memory, erasable programmable read-only memory, solid-state drives, ferroelectric radio access memory, magnetic random-access memory, onboard data storage systems, file systems, other types of non-terrestrial memory, or one or more combinations thereof.

The packet modification instructions 406A can be used by the one or more processors 404 to cause the one or more processors 404 to perform packet modification 404A. Example operations of the packet modification 404A may include modifying a packet, from a packet duplication, the multi-path trigger instructions 504A received from a user device, wherein the other packet from the packet duplication was transmitted from the user device to a terrestrial station. In some embodiments, the modification can include adding non-terrestrial station uplink data to the packet received from the packed duplication, the non-terrestrial station uplink data corresponding to the packet transmission from the user device to the non-terrestrial station 402.

In some embodiments, the non-terrestrial station 402 can perform packet modification 404A by error checking the packet received from the user device, encrypting modified packet data including the non-terrestrial station uplink data, decrypting data within the duplicated data packet, modulation or demodulation operations associated with the duplicated packet, other types of packet modification 404A operations, or one or more combinations thereof. In some embodiments, the packet modification 404A operations may include handling and interpreting the packet and adding the non-terrestrial station uplink data, adding terrestrial station radio frequency data (e.g., based on the terrestrial backhaul 112 of FIG. 1), adding other types of non-terrestrial station data, etc., or one or more combinations thereof. In some embodiments, the packet received by the non-terrestrial station 402 may include remote sensing data, payload data, control data, meteorological data, emergency data, non-terrestrial station downlink data, other types of packet data, or one or more combinations thereof.

In some embodiments, the packet modification 404A operations may include appending location information associated with the non-terrestrial station 402 to the packet received, appending location information associated with the user device, etc., or one or more combinations thereof. In some embodiments, the packet modified via the packet modification 404A operations can be transmitted (e.g., the communication of link data 404B) to a terrestrial station, to the user device that transmitted the packet to the non-terrestrial station, to another terrestrial network component, or one or more combinations thereof.

The signal determination instructions 406B may include the processing and relaying of one or more signals received from the user device via the non-terrestrial station uplink. In some embodiments, the one or more signals corresponding to the non-terrestrial station uplink may be processed based on the stored historical data 406D. In some embodiments, the signal determination instructions 406B may correspond to determining a frequency or bandwidth associated with the non-terrestrial station uplink. In some embodiments, the signal determination instructions 406B may correspond to a signal to interference plus noise ratio of the non-terrestrial station uplink, signal to noise ratio, another interference or signal strength measurement associated with an uplink between the user device and the non-terrestrial station, etc., or one or more combinations thereof. The communication of link data 404B may include communicating the processed one or more signals corresponding to the non-terrestrial station uplink to the terrestrial network via one or more terrestrial network components, communicating the link data 404B to another non-terrestrial station, etc., or one or more combinations thereof.

Receiving data 404C may include receiving terrestrial station uplink data from a terrestrial network, receiving terrestrial station downlink data from the terrestrial network, receiving timing and synchronization characteristics associated with the terrestrial station uplink data from the terrestrial network, receiving other types of uplink data or downlink data from the terrestrial network, or one or more combinations thereof. In some embodiments, the non-terrestrial station 402 can generate a trigger (e.g., trigger generation 404D) or modify the trigger (e.g., using the trigger generation and modification instructions 406C) based on the stored historical data 406D, the data received at 404C, the processed one or more signals corresponding to the signal determination instructions 406B, etc., or one or more combinations thereof.

By way of example, the trigger generation 404D may include generating a trigger to transmit to a user device that causes the user device to perform packet duplication, such that one packet from the packet duplication is to be transmitted from the user device to the non-terrestrial station 402 and such that another packet from the packet duplication is to be transmitted from the user device to a terrestrial station. In some embodiments, the trigger generated via trigger generation 404D may also cause the user device to stop the packet duplication (e.g., based on a radio frequency fluctuation of the non-terrestrial uplink being within a threshold range). In some embodiments, the trigger generation and modification instructions 406C may include instructions for changing the threshold range for the radio frequency fluctuation of the non-terrestrial uplink.

The stored historical data 406D may include historical non-terrestrial station uplink data corresponding to a user device, historical non-terrestrial station uplink data corresponding to a plurality of user devices, historical non-terrestrial station uplink data corresponding to user devices located at a cell edge of a terrestrial station, historical non-terrestrial station uplink data corresponding to user devices located at other locations other than the cell edge of the terrestrial station, etc., or one or more combinations thereof. In some embodiments, the packet modification 404A, communication of the link data 404B, receipt of the link data 404C, and trigger generation 404D operations of the non-terrestrial station may be performed based on the stored historical data 406D.

### Example User Device

Referring now to FIG. 5, a diagram is depicted of an example user device suitable for use in implementations of the present disclosure. In particular, the example computer environment is shown and designated generally as user device 500. User device 500 is but one example of a suitable computing environment and is not intended to suggest any limitation as to the scope of use or functionality of the invention. Neither should user device 500 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 5, user device 500 includes bus 502 that directly or indirectly couples the following devices: memory 504, one or more processors 506, one or more presentation components 508, input/output (I/O) ports 510, I/O components 512, power supply 514 and radio(s) 516. The memory 504 can include multi-path trigger instructions 504A and multi-path state operating instructions 504B, which can be executed by the processor(s) 506 to perform trigger generation and modification operations 506A and multi-path state operations 506B.

Although the components of FIG. 5 are shown with lines for the sake of clarity, in reality, delineating various components is not so clear, and metaphorically, the lines would more accurately be grey and fuzzy. For example, one may consider a presentation component, such as a display device to be one of I/O components 512. As another example, processors, such as one or more processors 506, have memory. The present disclosure hereof recognizes that such is the nature of the art, and reiterates that FIG. 5 is merely illustrative of an example computing environment for a user device that can be used in connection with one or more implementations of the present disclosure. Additionally, distinction is not made between such categories as “workstation,” “server,” “laptop,” “handheld device,” etc., as all are contemplated within the scope of FIG. 5 and refer to “computer” or “computing device.” In yet another example, bus 502 can represent what may be one or more busses (such as an address bus, data bus, or combination thereof).

User device 500 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data.

Computer storage media may include RAM, ROM, EEPROM, flash memory or other memory technology, CD-ROM, DVD or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, and other wireless media. Combinations of any of the above should also be included within the scope of computer-readable media.

In embodiments, memory 504 includes computer-storage media in the form of volatile and/or nonvolatile memory. Memory 504 may be removable, non-removable, or a combination thereof. Examples of memory 504 can include solid-state memory, hard drives, optical-disc drives, etc., or one or more combinations thereof. The multi-path trigger instructions 504A can be used by the one or more processors 506 to cause the one or more processors 506 to perform trigger generation and modification operations 506A. The multi-path state operating instructions 504B can be used by the one or more processors 506 to cause the one or more processors 506 to perform multi-path state operations 506B.

User device 500 also includes one or more processors 506 that read data from various entities, such as bus 502, memory 504, or I/O components 512. Examples of one or more processors 506 may include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, other types of processors or other suitable hardware configured to perform trigger generation and modification operations 506A using the multi-path trigger instructions 504A, other types of processors or other suitable hardware configured to perform multi-path state operations 506B using the multi-path state operating instructions 504B, or one or more combinations thereof.

In embodiments, the trigger generation and modification operations 506A may include generating the trigger itself that causes the user device 500 to perform packet duplication, such that one packet from the packet duplication is to be transmitted from the user device 500 to a non-terrestrial station and that another packet from the packet duplication is to be transmitted to a terrestrial station. In embodiments, the multi-path state operations 506B may include performing packet duplication by simultaneously transmitting one packet from the packet duplication to a non-terrestrial station and another packet from the packet duplication to a terrestrial station. For example, the packets from the packet duplication can be transmitted using the radio 516. As another example, the packets from the packet duplication are transmitted using RF link 102A and RF link 102B of FIG. 1.

In some embodiments, the trigger generation and modification operations 506A may include modifying a threshold that triggers the packet duplication. By way of example, the trigger can initiate the packet duplication, or stop the packet duplication, based on a number of HARQs that the user device 500 transmitted to the non-terrestrial station within a period of time. In some embodiments, the trigger can initiate the packet duplication, or stop the packet duplication, based on radio frequency fluctuations associated with the non-terrestrial station uplink. As such, in some embodiments, the trigger generation and modification operations 506A may include modifying the number of HARQs that triggers the packet duplication, modifying the radio frequency fluctuation threshold associated with the non-terrestrial station uplink, etc., or one or more combinations thereof.

In some embodiments, the multi-path state operations 506B may include utilizing, based on the packet duplication, a terrestrial station uplink over the non-terrestrial station uplink for one or more communications. In some embodiments, based on the packet duplication, the multi-path state operations 506B may include utilizing a non-terrestrial station downlink, over a terrestrial station downlink, for the one or more communications. In some embodiments, the multi-path state operations 506B may include a dynamic selection between the non-terrestrial station uplink and the terrestrial station uplink based on performing a plurality of packet duplications over a period of time.

In some embodiments, multi-path state operations 506B may include stopping the packet duplication based on a radio frequency fluctuation, corresponding to the non-terrestrial uplink, being within a threshold range. For example, the multi-path state operations 506B may also include initiating additional packet duplications at a time after previously stopping the packet duplication and upon the radio frequency fluctuation no longer being within the threshold range.

One or more presentation components 508 can present (e.g., to a person or other device) data indications (e.g., the multi-path trigger instructions 504A). Examples of the one or more presentation components 508 can include a display device, speaker, printing component, vibrating component, etc. I/O ports 510 can allow user device 500 to be logically coupled to I/O components 512 or other devices. In some embodiments, only a portion of a plurality of I/O components 512 may be built into user device 500. Illustrative I/O components 512 may include a microphone, joystick, game pad, satellite dish, scanner, printer, wireless device, etc., or one or more combinations thereof.

Radio 516 can represent a radio that facilitates communication with a wireless telecommunications network. Illustrative wireless telecommunications technologies may include CDMA, GPRS, TDMA, GSM, and the like. Radio 516 might additionally or alternatively facilitate other types of wireless communications including Wi-Fi, WiMAX, LTE, or other VoIP communications. As can be appreciated, in various embodiments, radio 516 can be configured to support multiple technologies and/or multiple radios can be utilized to support multiple technologies. By way of example, the radio 516 can be configured to support an 8-element MIMO antenna configuration for 5G smartphones or another number of elements for various antenna configurations for other generation smartphones or user devices for implementing the multi-path state operations 506B.

A wireless telecommunications network might include an array of devices, which are not shown so as to not obscure more relevant aspects of the invention. Components, such as a base station, a communications tower, or even access points (as well as other network components), can provide wireless connectivity in some embodiments.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

In the preceding Detailed Description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

In addition, in the preceding Detailed Description, words such as “a” and “an,” unless otherwise indicated to the contrary, may also include the plural as well as the singular. Thus, for example, the constraint of “a feature” is satisfied where one or more features are present. Furthermore, the term “of” includes the conjunctive, the disjunctive, and both (a or b thus includes either a or b, as well as a and b). Further, the term “some” may refer to “one or more.” Additionally, an element in the singular may refer to “one or more.” The term “plurality” may refer to “more than one.”

In the preceding Detailed Description, “computer storage media” does not comprise signals per se.

The invention claimed is:

1. A system for terrestrial and non-terrestrial coordination functionality, the system comprising:
one or more processors; and
computer memory storing computer-usable instructions that, when executed by the one or more processors, cause the one or more processors to perform operations comprising:
transmitting a trigger to a user device that causes the user device to perform packet duplication, such that a first packet from the packet duplication is to be transmitted from the user device to a non-terrestrial station and such that a second packet from the packet duplication is to be transmitted from the user device to a terrestrial station;
receiving, based on the trigger, non-terrestrial station uplink data from the non-terrestrial station that corresponds to the first packet transmitted from the user device; and
receiving, based on the trigger, terrestrial station uplink data from the terrestrial station that corresponds to the second packet transmitted from the user device.

2. The system according to claim 1, the operations further comprising:
adding a combination of the terrestrial station uplink data and the non-terrestrial station uplink data to each packet from the packet duplication; and
transmitting, to the user device, each packet from the packet duplication that includes the combination of the terrestrial station uplink data and the non-terrestrial station uplink data.

3. The system according to claim 1, wherein the user device is located within a cell edge associated with the terrestrial station, and wherein the trigger causes the user device to perform the packet duplication based on the user device being located within the cell edge.

4. The system according to claim 1, the operations further comprising:
comparing the non-terrestrial station uplink data to the terrestrial station uplink data; and
causing the user device to utilize a terrestrial station uplink for a communication based on comparing the non-terrestrial station uplink data to the terrestrial station uplink data.

5. The system according to claim 4, wherein the non-terrestrial station uplink data includes a signal to interference plus noise ratio associated with an uplink between the user device and the non-terrestrial station.

6. The system according to claim 4, the operations further comprising:
receiving, based on the trigger, non-terrestrial station downlink data from the user device;
receiving, based on the trigger, terrestrial station downlink data from the user device; and
causing the user device to utilize a non-terrestrial station downlink for the communication based on comparing the non-terrestrial station downlink data to the terrestrial station downlink data.

7. The system according to claim 1, wherein the trigger also causes the user device to stop the packet duplication upon the operations further comprising determining that a radio frequency fluctuation, corresponding to a plurality of non-terrestrial uplink data received upon the user device performing a plurality of packet duplications, is within a threshold range.

8. The system according to claim 7, the operations further comprising:
determining that the user device has stopped the packet duplication based on determining that the radio frequency fluctuation is within the threshold range;
at a time after determining that the radio frequency fluctuation is within the threshold range, determining that the radio frequency fluctuation is no longer within the threshold range;
based on the radio frequency fluctuation no longer being within the threshold range and based on the trigger, receiving, from the non-terrestrial station, additional non-terrestrial station uplink data;
based on the radio frequency fluctuation no longer being within the threshold range and based on the trigger, receiving, from the terrestrial station, additional terrestrial station uplink data; and
combining the additional terrestrial station uplink data and the additional non-terrestrial station uplink data for transmission to the user device.

9. The system according to claim 1, wherein the trigger causes the user device to transmit the first packet and the second packet via the same frequency band.

10. A method for terrestrial and non-terrestrial coordination functionality, the method comprising:
transmitting, via one or more network components, a trigger to a user device that causes the user device to perform packet duplication, such that a first packet from the packet duplication is to be transmitted from the user device to a non-terrestrial station and that a second packet from the packet duplication is to be transmitted from the user device to a terrestrial station; and
causing, via the one or more network components and based on the user device performing the packet duplication, the user device to utilize a terrestrial station uplink over a non-terrestrial station uplink.

11. The method according to claim 10, wherein the user device is caused to utilize the terrestrial station uplink over the non-terrestrial station uplink based on:
receiving, via the one or more network components and from the non-terrestrial station, non-terrestrial station uplink data;
receiving, via the one or more network components and from the terrestrial station, terrestrial station uplink data;
combining, via the one or more network components, the non-terrestrial station uplink data and the terrestrial station uplink data; and
transmitting, via the one or more network components, the combined non-terrestrial station uplink data and terrestrial station uplink data to the user device.

12. The method according to claim 10, further comprising:
determining, via the one or more network components, that the user device has transmitted a number of Hybrid Automatic Repeat Requests (HARQs) to the non-terrestrial station, within a period of time, that is over a threshold; and
causing the user device to utilize the terrestrial station uplink based on the number of HARQs being over the threshold.

13. The method according to claim 10, further comprising:
receiving, via the one or more network components and based on the user device performing the packet duplication, non-terrestrial station downlink data and terrestrial station downlink data;
combining the non-terrestrial station downlink data and the terrestrial station downlink data; and
causing the user device to utilize a non-terrestrial station downlink over a terrestrial station downlink based on combining the non-terrestrial station downlink data and the terrestrial station downlink data.

14. The method according to claim 10, wherein the non-terrestrial station uplink and the terrestrial station uplink correspond to the same frequency band.

15. The method according to claim 14, wherein the trigger also causes the user device to stop the packet duplication upon the one or more network components further determining that a plurality of radio frequency measurements, measured within a period of time and corresponding to the non-terrestrial station uplink, are within a threshold range.

16. The method according to claim 10, further comprising:
determining, via the one or more network components and based on the user device performing the packet duplication, that a signal strength of a non-terrestrial station downlink is below a threshold; and
causing the user device to utilize the terrestrial station uplink based on the signal strength of the non-terrestrial station downlink being below the threshold.

17. One or more non-transitory computer storage media having computer-executable instructions embodied thereon, that when executed by at least one processor, cause the at least one processor to perform a method comprising:
transmitting a trigger to a user device that causes the user device to perform packet duplication, such that a first packet from the packet duplication is to be transmitted from the user device to a non-terrestrial station and that a second packet from the packet duplication is to be transmitted from the user device to a terrestrial station;
receiving, based on the user device performing the packet duplication, non-terrestrial station uplink data and terrestrial station uplink data;
combining the non-terrestrial station uplink data and the terrestrial station uplink data; and
dynamically selecting between a non-terrestrial station uplink and a terrestrial station uplink for a user device communication based on the combination of the non-terrestrial station uplink data and the terrestrial station uplink data.

18. The one or more non-transitory computer storage media of claim 17, wherein the dynamic selection between the non-terrestrial station uplink and the terrestrial station uplink is further based on receiving, from the user device, a number of Hybrid Automatic Repeat Requests (HARQs) that the user device transmitted to the non-terrestrial station within a period of time.

19. The one or more non-transitory computer storage media of claim 17, wherein the dynamic selection between the non-terrestrial station uplink and the terrestrial station uplink is further based on receiving, from the user device, a signal strength of a non-terrestrial station downlink of the non-terrestrial station.

20. The one or more non-transitory computer storage media of claim 17, wherein the trigger is transmitted based on determining that the user device is located within a cell edge associated with the terrestrial station.
